(19) United States
(12) Patent Application Publication
(10) Pub. No.: US 2008/0029394 A1
(43) Pub. Date: Feb. 7, 2008

(54) Stackable horizontal gel apparatus

(76) Inventor: Stephen Liye Chen, El Monte, CA (US)

Correspondence Address: Stephen Liye Chen, 12331 Felipe Street, El Monte, CA, 91732, US

(21) Appl. No.: 11/500,022

(22) Filed: Aug. 7, 2006

(51) Int. Cl. G01N 27/00

(52) U.S. Cl. 204/606

(57) ABSTRACT

Stackable horizontal gel system is introduced. Multiple units of apparatuses can be stacked together in a pile. Stacking gaps between every two neighboring units can be used to store gels for a month without wrapping. Engagement of every two units of neighboring apparatus forms a seal to prevent liquid loss of gel in storage.

### FIELD OF THE INVENTION

The present invention relates generally to devices of gel electrophoresis. More specifically, it relates to modifications of a horizontal gel apparatus for easy gel storage.

### BACKGROUND OF THE INVENTION

Horizontal gel electrophoresis has been one of the most useful tools in biomedical research and industries. Two steps are involved in the process, a preparation of an agarose gel and then an electrophoresis using the gel. During the agarose gel preparation, agarose powder in a certain weight is mixed with a buffer in a certain volume to form a gel liquid. The gel liquid needs to be heated to over 100 degree and then cooled down to about 65 degree before adding ethidium bromide. After a period of waiting time the gel liquid solidifies in a mold, which is used for electrophoresis.

The booming of modern biotechnology requires rapid pace of experiments. Attempts have been made to omit the requirement of a single gel preparation before electrophoresis. Kirkpatrick et al, in U.S. Pat. No. 5,443,704, teaches a gel preformed commercially by industry. Dale et al. in U.S. Pat. No. 6,632,340, modifies a precast gel in order to enhance its usability. Unfortunately, commercial precast gels are rejected by the majority of users in practice due to their problems as follows:
a. Quality of electrophoresis is reduced due to their failure in optimizing electric compatibility between the precast gel and a variety of different gel apparatuses.
b. Speed of their electrophoresis has to be reduced even slower than the speed of old methods in order to obtain acceptable quality.
c. Users have no freedom to change sample well format to meet diversified applications.
d. Gel price is dramatically increased.

It is highly desirable to overcome the problems of commercial precast gels. But the problems remain unsolved.

### SUMMARY OF THE INVENTION

It is, therefore, an object of the invention to overcome the problems of commercial precast gels. The advantages of the invention over prior arts are summarized as follows:
1. It saves time. Users can pour 10 or more gels at once instead of a single gel.
2. It offers user freedom. Users can select any comb combination to meet their special needs.
3. It ensures high quality. Gels are formed inside user's own apparatus, which ensures an optimal electric field during electrophoresis.
4. It reduces cost. High price of commercial precast gels is avoided. High cost of manpower in single gel preparation is avoided.

### BRIEF DESCRIPTION OF THE DRAWINGS

FIG. 1 is an illustrative diagram of the invention.

FIG. 2 demonstrates how to use a gel for electrophoresis.

FIGS. 3a and 3b are sectional views of one embodiment of the invention.

FIG. 4 shows additional advantages of the invention.

### DETAILED DESCRIPTION OF THE INVENTION

Before electrophoresis, a preparation of a single gel takes over half-hour. But 10 gels can also be made simultaneously within the similar time range. But there is a problem. A single gel can be used for electrophoresis immediately after its preparation. But 10 gels have to be stored properly before their use for electrophoresis. How to store 10 or more gels easily without occupying a large space or individual wrapping?

A simple strategy of the invention has solved the problem, making multiple units of apparatus stackable so that multiple gels can be stored together in a pile for space saving. After stacking, an engagement of two neighboring units of the apparatuses seals a gel inside. Individual wrapping is omitted.

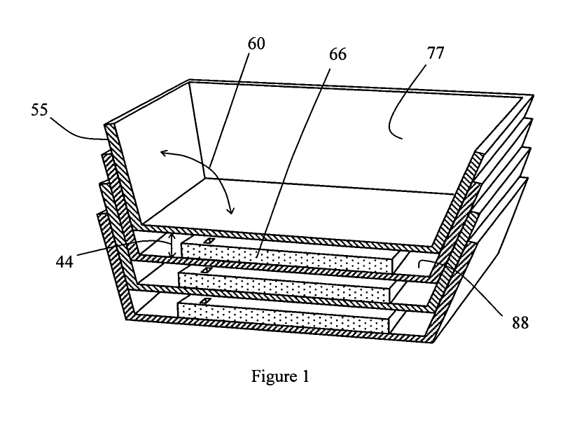

FIG. 1 shows 4 units of apparatus 55 being stacked together. All units are made identical in dimension and structure. For visual explanation, front portion of apparatus 55 is removed to show a gel 66 on a bottom 88 being stored in a stacking gap 44. Stacking gap 44 is the space between two neighboring units in a stacking pile. Walls 77 are tilted outwards to make multiple units of apparatus 55 stackable.

A special angle 60 plays an important role in the invention. Angle 60 is defined as a measurement between bottom 88 and walls 77. When angle 60 being designed to a certain value, such as 101 degree, all units of apparatus 55 can be stacked together and result in stacking gap 44 at 10 mm, which is little greater than the 6mm thickness of gel 66. Stacking gap 44 in 10 mm has two advantages:
a. It reduces storage space while still preventing damages to gel 66 in stacking pile.
b. It increases overlapping of walls 77 between two neighboring units of apparatus 55. Such overlapping engagement of walls 77 forms a seal to reduce liquid loss of gel 66 during storage period.

When angle 60 is less than 101 degree, such as 95 degree, stacking gap 44 becomes unnecessarily large for gel storage. The overlapping length of walls 77 between neighboring units is reduced, which results in poor sealing.

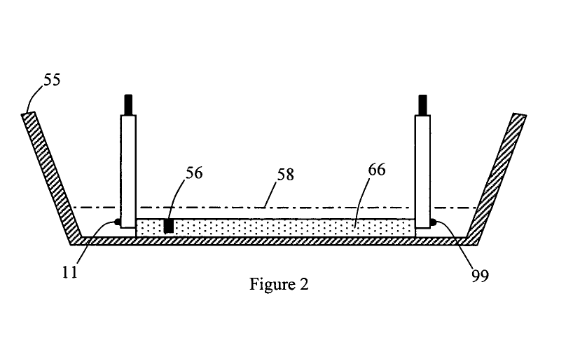

FIG. 2 demonstrates how to use gel 66 for horizontal electrophoresis after storage. Its operation steps are as follows:
1. Take one unit of apparatus 55 from stacked pile, including a piece of gel 66 inside.
2. Add buffer 58 to immerse gel 66.
3. Place a pair of electrodes, 11 and 99, to each end of gel 66 in apparatus 55.
4. Load samples into wells 56.
5. Conduct an electric current across gel 66 via buffer 56 and electrodes pair 11 and 99.

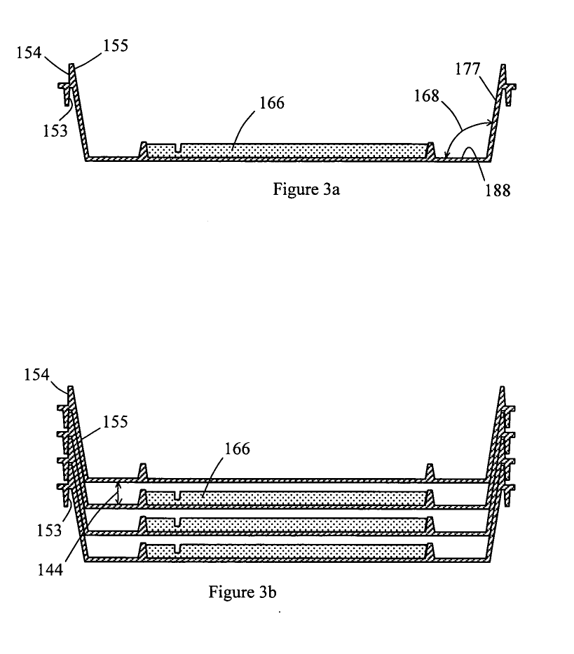

FIGS. 3a and 3b are sectional views of one embodiment of the invention. FIG. 3a shows a sectional view of an apparatus 155 containing a gel 166. An angle 168 is 101 degree between a bottom 188 and walls 177. Storage of gel 166 is secured by two designs:
1. All units of apparatus 155 are made by precise injection molding to ensure a tight fitting of walls 177 between every two neighboring units. Consistent wall thickness, radius, and angles can be maintained from unit to unit.
2. Along edge line of walls 177, a pair of mating shapes is added. Each unit of apparatus 155 has a male shape 154 and a female shape 153. Both shapes are compatible to form a tightly fit. In a stacking pile, male shape 154 of a bottom unit engages female shape 153 of a top unit, as shown in FIG. 3b.

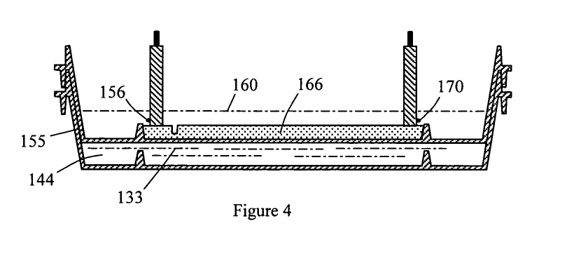

Stackable apparatus 155 offers additional advantage of rapid electrophoresis. FIG. 4 shows two units of apparatus 155 being stacked together for high voltage electrophoresis. A pair of removable electrodes, 156 and 170 conducts electric current across gel 166 via a buffer 160. High voltage drives high-speed electrophoresis and generates extra heat. A cold water 133 can be added into bottom unit to fill stacking gap 144 for absorbing heat from gel 166 during electrophoresis.

Although the descriptions above contains specifications, it is apparent to those who skilled in the art that a number of other variations and modifications can be made to the invention without departing from its spirit and scope. Mating shapes 153 and 154, for example, can be omitted. Angle 168 can be altered to 103 degree. Stacking gap 144 can be greater than 10 mm. Therefore, the descriptions as set out above should not be constructed as limiting the scope of the invention but as merely providing illustration of the presently preferred embodiment of the invention.

1. A modification of an apparatus for a storage of a gel for an electrophoresis, comprising;
multiple units of said apparatus, each unit having a bottom and walls;
an angle, measured between said bottom and said walls, being set to result in two parameters of:
(a) said multiple units of said apparatus being stackable;
(b) a stacking gap, between two neighboring units in said stacking pile, being greater than a thickness of said gel;
an engagement, between two neighboring units of said apparatus in said stacking pile, forming a seal for reducing liquid loss of said gel during said storage.

2. The modification of an apparatus as claimed in claim 1 wherein said angle is greater than 95 degree.

3. A modification of an apparatus for a storage of a gel for an electrophoresis, comprising;
multiple units of said apparatus:
walls of said apparatus being tilted outwards to create:
(a) a stacking pile of said apparatus,
(b) a stacking gap, between two neighboring units in said stacking pile, being greater than a thickness of said gel;
an engagement, between two neighboring units of said apparatus in said stacking pile, reducing liquid loss of said gel during said storage.
